(19) United States
(12) Patent Application Publication
(10) Pub. No.: US 2007/0177232 A1
(43) Pub. Date: Aug. 2, 2007

(54) Image forming apparatus, calibration control method, and storage medium

(76) Inventor: Naoki Takeuchi, Osaka (JP)

Correspondence Address: MURAMATSU & ASSOCIATES, Suite 310, 114 Pacifica, Irvine, CA, 92618, US

(21) Appl. No.: 11/345,701

(22) Filed: Feb. 2, 2006

(51) Int. Cl. G06F 15/00

(52) U.S. Cl. 358/504; 358/1.9

(57) ABSTRACT

There is provided an image forming apparatus including a calibration performance managing unit 131 that controls the performance of the calibration based on a request for a predetermined calibration; a calibration performance unit 132 that performs various types of calibrations in response to an instruction from the calibration performance managing unit 131; and a calibration history managing unit 133 that stores the end times and types of the performed calibrations. When, while a calibration is being performed, a request is made for another calibration of the same type as the calibration being performed, the another calibration is not performed.

### BACKGROUND OF THE INVENTION

1. Field of the Invention

The present invention relates to an image forming apparatus having a plurality of types of calibration functions. More particularly, the present invention relates to an image forming apparatus that performs more efficient image processing by performing predetermined contention control upon performing calibration.

2. Description of the Related Art

Conventionally, in an image forming apparatus which is represented by a color printer or the like, due to, for example, changes in environment where the apparatus is placed or deterioration or wear of components, the electrical or mechanical conditions for image formation and output may change. As a result, even if the same image is outputted, the color or density may vary from output image to output image.

In view of this, an image forming apparatus such as a color printer, is provided with a color correction function called “calibration” that suppresses the color change or density reduction of an output image, whereby a certain image quality is maintained for the output image.

For the types of calibration, there are a plurality of types of calibration functions such as a bias calibration in which a correction is performed by adjusting biases and an I/O calibration in which a correction is performed by setting the gradient (γ table) of color density for actual image output by arithmetic processing. According to the specifications, settings, application mode, or the like of an image forming apparatus, various types of calibrations are performed (see, for example, Japanese Patent Application Laid-open No. 2002-296851 (pp. 8-9, FIG. 6)).

Calibrations as described above have an advantage in that a certain image quality can be maintained for an output image, but also have disadvantages in that other processes such as printing cannot be performed while a calibration is being performed, and in addition, extra toner is used for generating a test pattern. Thus, it is not desirable to needlessly perform calibration. In view of this, there has been proposed an image forming apparatus in which the timing at which calibration is performed is efficiently controlled according to an output mode or the like so as to minimize the frequency of calibration (see, for example, Japanese Patent Application Laid-open No. 11-177822 (pp. 1-2, FIG. 2)).

### SUMMARY OF THE INVENTION

Calibration control methods having been proposed so far as described above, can control calibration performance timing which is suitable for the characteristics of individual images to be outputted, but cannot control the timing at which the individual calibrations are performed when a plurality of calibrations contend with each other.

Hence, when, for example, a plurality of calibrations of the same type contends at the same timing, the calibration of the same type is performed overlappingly or repeatedly. Accordingly, the problems of conventional art still remain unsolved.

The present invention is proposed to solve problems of conventional technique as described above. An object of the present invention is to provide an image forming apparatus that surely prevents a calibration of the same type from being repeatedly performed, by performing predetermined contention control upon performing calibration, enabling efficient image processing, a calibration control method, and a storage medium.

To attain the above object, according to a first aspect of the present invention, there is provided an image forming apparatus having one or two or more types of calibration functions that are performed to maintain a predetermined image quality for an output image, the apparatus including:

a calibration performance unit that performs a predetermined calibration; and

a calibration performance managing unit that controls the calibration performance unit based on a request for a predetermined calibration to perform the requested predetermined calibration when no calibration is performed, and controls the calibration performance unit not to perform the requested calibration of the same type when a request is made for another calibration of a same type as the calibration being performed while a calibration is being performed.

According to a second aspect of the present invention, the image forming apparatus has a structure in which when a request is made for another calibration of a different type from the calibration being performed while a calibration is being performed, the calibration performance managing unit controls the calibration performance unit to wait for the calibration being performed to end and then perform the requested calibration of the different type.

According to a third aspect of the present invention, the image forming apparatus further includes a calibration history managing unit that stores calibration history information including a type and an end time of a calibration performed by the calibration performance unit,

wherein when a request for a calibration is made, the calibration performance managing unit controls, the calibration performance unit not to perform the requested calibration based on a determination that a calibration of a same type as the requested calibration is already performed within a predetermined period of time by the calibration history information stored in the calibration history managing unit.

According to a fourth aspect of the present invention, the image forming apparatus has a structure in which calibration to be performed by the calibration performance unit includes an I/O calibration and/or a bias calibration.

According to the image forming apparatus of the present invention having such configurations, during or after the performance of a given calibration, a calibration of the same type occurred at predetermined timing is prevented from being performed; thus, overlapped calibration processes are avoided. Specifically, when there is a calibration being performed, a calibration of the same type as the calibration being performed is not performed. In addition, even when there is no calibration being performed, the performance of a calibration of the same type within a preset, predetermined period of time is avoided.

In this manner, in the present invention, an effective calibration process is performed while suppressing unnecessary performance, making it possible to perform image formation and output with a certain image quality being maintained, and to suppress the consumption of extra toner. In addition, the waiting time during which a print process cannot be performed because calibration is being performed, can be reduced as possible. Accordingly, the work efficiency of the entire image forming apparatus can be improved.

Furthermore, an optimum interval for calibration performance and the like can be set based on the type of calibration. Thus, a flexible operation can be performed according to the type or content of an image, the user's status of use or the like, enabling a more efficient image formation process.

According to fifth aspect of the present invention, there is provided a calibration control method which is performed by a calibration performance managing unit, in an image forming apparatus having one or two or more types of calibration functions, the method including:

controlling a calibration performance unit not to perform the requested calibration of the same type when, while a calibration is being performed, a request is made for another calibration of a same type as the calibration being performed;

controlling the calibration performance unit to wait for the calibration being performed to end and then perform the requested calibration of the different type when, while a calibration is being performed, a request is made for another calibration of a different type from the calibration being performed;

storing calibration history information including a type and an end time of a calibration performed by the calibration performance unit; and

controlling, when a request for a calibration is made, the calibration performance unit not to perform the requested calibration based on a determination that a calibration of a same type as the requested calibration is performed within a predetermined period of time by the calibration history information stored in the calibration history managing unit.

As such, the present invention can also be provided in the form of a method.

According to sixth aspect of the present invention, there is provided a storage medium having stored thereon an image processing program that allows a computer that composes an image forming apparatus having one or two or more types of calibration functions which are performed to maintain a predetermined image quality for an output image, to function as:

calibration performance means for performing a predetermined calibration; and

calibration performance management means for controlling, the calibration performance means based on a request for a predetermined calibration to perform the requested predetermined calibration when no calibration is performed, and controlling, the calibration performance means not to perform the requested calibration of the same type when, while a calibration is being performed, a request is made for another calibration of a same type as the calibration being performed.

As such, the present invention can also be provided in the form of a storage medium having an image processing program stored thereon.

According to seventh aspect of the present invention, there is provided the storage medium in which the image processing program is recorded, wherein the image processing program allows the calibration performance management means to function as:

means for controlling the calibration performance means to wait for the calibration being performed to end and then perform the requested calibration of the different type when, while a calibration is being performed, a request is made for another calibration of a different type from the calibration being performed.

As such, the present invention can also be provided in the form of a storage medium having an image processing program stored thereon.

According to eighth aspect of the present invention, there is provided the storage medium stored thereon an image processing program, wherein the image processing program allows the computer that composes an image forming apparatus having one or two or more types of calibration functions which are performed to maintain a predetermined image quality for an output image to function as calibration history management means for storing calibration history information including a type and an end time of a calibration performed by the calibration performance means, and the image processing program allows, when a request for a calibration is made, the calibration performance management means to function as means for controlling, the calibration performance means not to perform the requested calibration based on a determination that a calibration of a same type as the requested calibration is already performed within a predetermined period of time by the calibration history information stored in the calibration history management means.

As such, the present invention can also be provided in the form of a storage medium having an image processing program stored thereon.

According to an image forming apparatus of the present invention, by performing predetermined contention control upon performing calibration, a calibration of the same type is surely prevented from being repeatedly performed, enabling efficient image processing.

By this, it becomes possible to output an image with a certain image quality being maintained while suppressing the number of times that calibration is performed, and an unusable time (waiting time) during the performance of calibration can be reduced as possible. In addition, the consumption of extra toner can be reduced; accordingly, an efficient operation of the entire image forming apparatus can be realized.

### BRIEF DESCRIPTION OF THE DRAWINGS

FIG. 1 is a block diagram of an image forming apparatus according to one embodiment of the present invention.

FIG. 2 is a flowchart showing calibration contention control performed in the image forming apparatus according to one embodiment of the present invention.

FIG. 3 is a sequence diagram showing contention control in the image forming apparatus according to one embodiment of the present invention, performed when a request for a bias calibration is made while an IO calibration and a bias calibration are being performed.

### DESCRIPTION OF THE PREFERRED EMBODIMENT

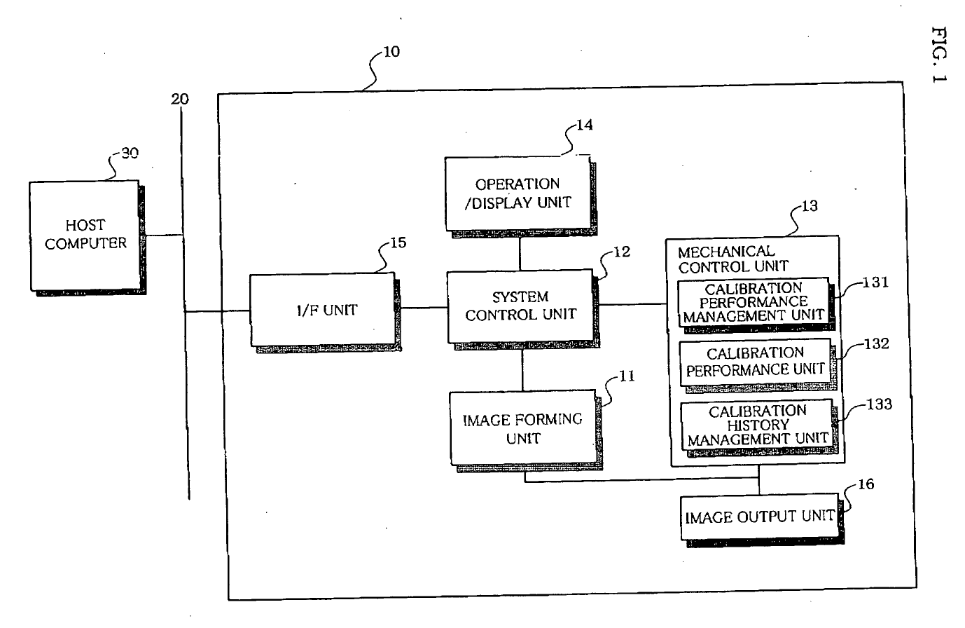

A preferred embodiment of an image forming apparatus of the present invention will be described below with reference to FIGS. 1 to 3.

An image forming apparatus of the present embodiment shown below is implemented by the processes, means, and functions executed by a computer in response to instructions of a program (an image processing program, software). The program sends an instruction to each component of the computer and allows the computer to perform predetermined processes and functions as shown below. Specifically, each process and means of the image forming apparatus of the present embodiment is implemented by specific means in which the program and the computer cooperate with each other.

Note that all or part of the program is provided by, for example, a magnetic disk, an optical disk, a semiconductor memory, or any other computer readable storage media. A program read from a storage medium is installed on the computer and executed. A program can also be directly loaded on the computer through a communication line instead of through a storage medium, and executed

FIG. 1 is a block diagram of the image forming apparatus according to one embodiment of the present invention.

An image forming apparatus 10 of the present invention includes an image forming unit 11, a system control unit 12, a mechanical control unit 13, an operation/display unit 14, an I/F unit 15, and an image output unit 16. The image forming apparatus 10 is connected to a host computer 30 through a communication line 20.

The image forming unit (image forming means) 11 generates image data such as bitmap data based on image information sent from the host computer 30 and then transmits the image data to the image output unit 16.

The system control unit (system control means) 12 performs various control on each unit of the image forming apparatus 10 or performs arithmetic processing. Specifically, the system control unit 12 includes, for example, a CPU that composes a microcomputer, ROM (Read Only Memory) that stores an image processing program, and RAM (Random Access Memory) that temporarily stores data.

The mechanical control unit (mechanical control means) 13 mainly controls the image output unit 16. In particular, the mechanical control unit 13 plays the main role in calibration contention control of the present embodiment.

Thus, the mechanical control unit 13 has a calibration performance managing unit 131, a calibration performance unit 132, and a calibration history managing unit 133. Each unit has a function necessary for calibration contention control.

The calibration performance managing unit (calibration performance management means) 131 receives a request for a predetermined calibration and controls the performance of the calibration.

Specifically, the calibration performance managing unit 131 receives a request for a calibration from the image forming unit 11, the system control unit 12, the operation/display unit 14, or the like. Then, based on a predetermined condition, the calibration performance managing unit 131 performs control such as rejecting the request or instructing the calibration performance unit 132 to perform the calibration.

There are a plurality of types of calibrations such as a bias calibration in which the grid potential of a photosensitive drum or the developing bias potential is adjusted, and an I/O calibration in which the output density or tone characteristics in image formation is (are) corrected by, for example, updating the contents of a gamma correction table in image processing, along with a bias calibration. A request for such calibrations is made at individual timing.

In the present embodiment, among such a plurality of types of calibrations, when calibrations of the same type, contend and overlap at predetermined timing, the calibration performance managing unit 131 performs predetermined contention control so as to avoid overlapped processes.

Calibrations of the same type that contend and overlap indicate not only two bias calibrations or two I/O calibrations but also other calibrations; for example, since the same process as a bias calibration is performed during an I/O calibration, the case in which a request for a bias calibration is made during or after the performance of an I/O calibration also applies to the contention and overlap of calibrations.

The calibration contention control will be described in detail later.

The calibration performance unit (calibration performance means) 132 performs various types of calibrations in response to an instruction from the calibration performance managing unit 131.

The calibration history managing unit (calibration history management means) 133 temporarily stores the end times and types of calibrations performed by the calibration performance unit 132. The stored information is used as dada necessary for calibration contention control, as will be described later.

The operation/display unit (operation means and display means) 14 is directly operated by a user when calibration is arbitrarily performed, to give an instruction to perform the calibration.

In addition, the operation/display unit 14 includes a display function that provides a result display, an operation aid associated with the operation, and the like. The operation/display unit 14 is normally composed of a liquid crystal panel, keys, and the like.

The I/F unit 15 is an interface with an external device. In the present embodiment, the main function of the I/F unit 15 is to capture image data sent from the host computer 30 through the communication line 20, and then transfer the image data to the image forming unit 11 under control of the system control unit 12.

The image output unit (image output means) 16 mainly prints and outputs image data generated in the image forming unit 11, under control of the mechanical control unit 13.

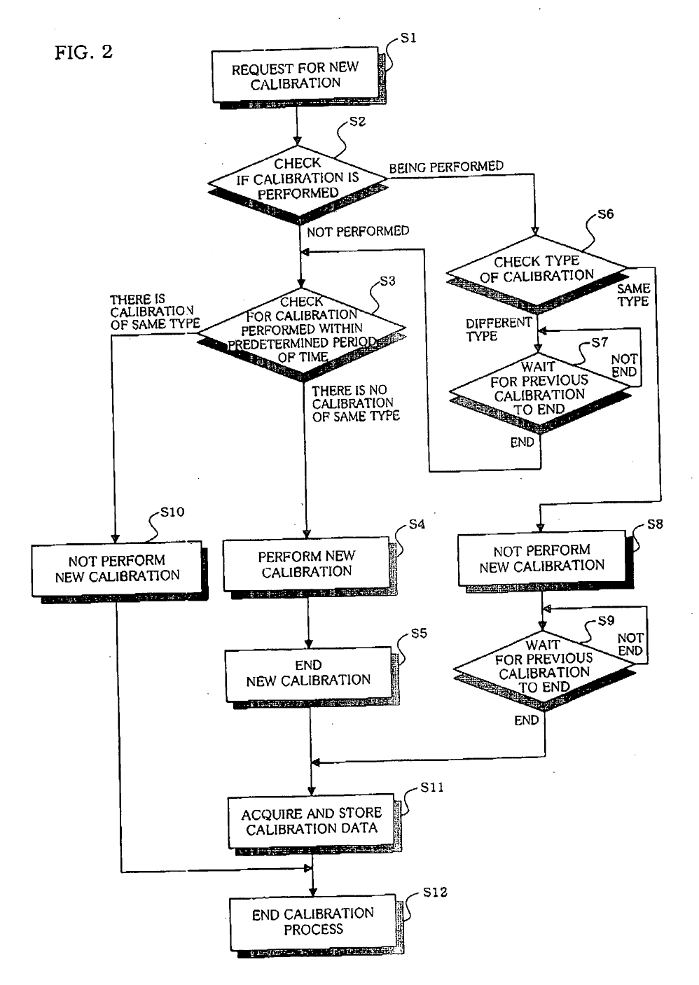

Now, calibration contention control (calibration control method) performed in an image forming apparatus having the above-described configuration will be described with reference to FIG. 2.

FIG. 2 is a flowchart showing calibration contention control performed in the image forming apparatus according to one embodiment of the present invention.

The basic operation is as follows. First, image data from the host computer 30 is sent through the communication line 20, and the image forming apparatus 10 having received the image data prints and outputs the image data.

Assuming that the image forming apparatus 10 has a calibration function, since a request for a calibration is made at various timing, such as every certain number of print sheets, every certain period of elapsed time, or any arbitrary timing by a user, the requests for or performance of calibrations may overlap.

The present embodiment is characterized by performing contention control when calibration processes overlap, as in the above case.

First, when a request for a new calibration is made (step S1), it is checked if there is another calibration being performed.

If there is no other calibration being performed, processing proceeds to step S3, and if there is another calibration being performed, processing proceeds to step S6 (step S2).

At step S6, the type of the calibration currently being performed is checked, and if the type is the same as that of the new calibration, the new calibration is not performed (steps S6 and S8). Then, when the calibration being performed ends (step S9), data of the end time and type and the like of the calibration is acquired and stored (step S11), and a series of calibration processes end (step S12).

On the other hand, if, at step S6, the type of the calibration is different from that of the new calibration, processing waits for the calibration being performed to end and then proceeds to step S3 (steps S6, S7, and S3).

At step S3, calibrations are extracted that are performed before the request for the new calibration is made and within a predetermined period of time. If there is, among the calibrations, a calibration of the same type as the requested calibration, without performing the requested calibration (steps S3 and S10), the calibration process ends (step S12).

On the other hand, at step S3, if, within the predetermined period of time, there is no calibration of the same type as the requested calibration, the requested calibration is performed (steps S3 and S4). Then, after the performance of the calibration ends (step S5), the end time and type of the calibration are acquired and stored (step S11) and a series of calibration processes end (step S12).

Note that the data acquired at step S11 is stored in the calibration history managing unit 133 as data necessary for subsequent calibration contention control, and is used for the determination at step S3.

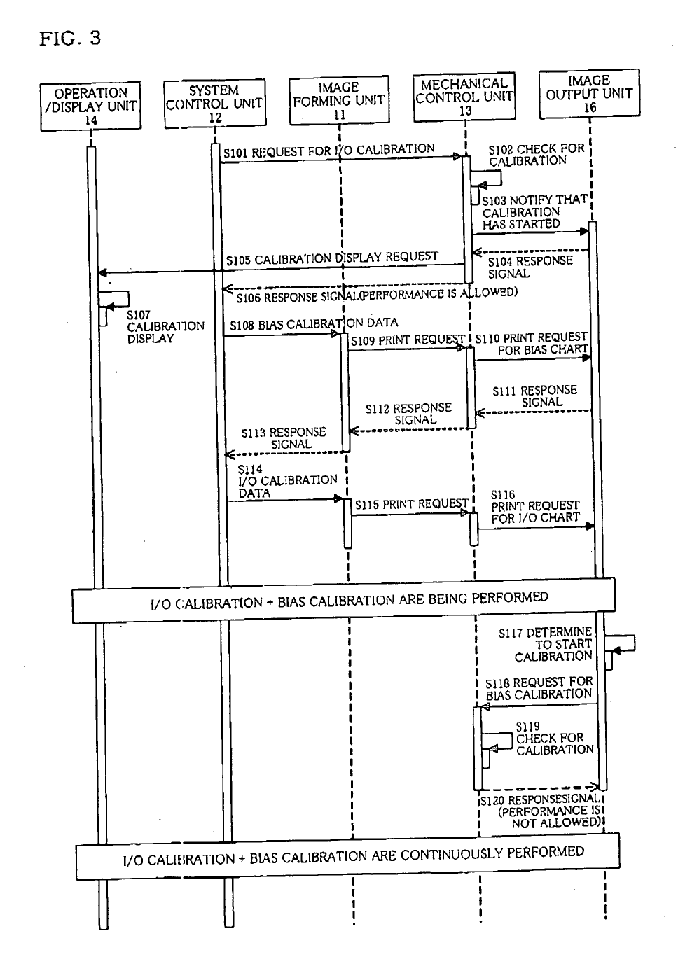

Now, calibration contention control performed in an image forming apparatus having the above-described configuration will be described in detail with reference to FIG. 3.

FIG. 3 is a sequence diagram showing contention control in the image forming apparatus according to an embodiment of the present invention, performed when, while an I/O calibration (including a bias calibration) is being performed, a request for another bias calibration is made.

First, it is assumed that a request for an I/O calibration is made to the mechanical control unit 13 from the system control unit 12 (S101).

In response to this, the mechanical control unit 13 checks if there is another contending calibration (S102).

If, as a result, it is found that there is no contending calibration, the performance of the requested I/O calibration is allowed, and a series of calibration processes start.

Then, the mechanical control unit 13 notifies to the image output unit 16 that the calibration process has started (S103).

When the mechanical control unit 13 verifies that the image output unit 16 has received the notification (S104), the mechanical control unit 13 notifies the system control unit 12 that the request for the calibration is allowed (S106), and at the same time, makes a calibration display request to the operation/display unit 14 (S105).

The operation/display unit 14 having received the calibration display request displays that calibration is being performed (S107). By this, the user can recognize that calibration is currently being performed.

On the other hand, the system control unit 12 that is the requester of the calibration sends, in a next stage, bias calibration data and I/O calibration data that are necessary to perform an I/O calibration, to the image forming unit 11 (S108 to S116).

Here, bias calibration data is sent first to the image forming unit 11 (S108) in order to perform a bias calibration at the beginning.

The image forming unit 11 having received the bias calibration data then makes a print request for the bias calibration data to the mechanical control unit 13 (S109). Subsequently, the mechanical control unit 13 makes a print request for a bias chart to the image output unit 16 (S110).

Note that S111, S112, and S113 are response signals to S110, S109, and S108, respectively.

Then, in order to perform an I/O calibration, the system control unit 12 sends I/O calibration data to the image forming unit 11 (S114).

The image forming unit 11 having received the I/O calibration data then makes a print request for the I/O calibration data to the mechanical control unit 13 (S115). Subsequently, the mechanical control unit 13 makes a print request for an I/O chart to the image output unit 16 (S116).

As shown in FIG. 3, at this point, in the image forming apparatus of the present embodiment, two calibration processes of the bias calibration and the I/O calibration, are being performed.

Under such circumstances, in the image forming apparatus of the present embodiment, it is determined by an image output unit 16 itself that a bias calibration is necessary (S117). Accordingly, a request for a bias calibration is made (S118).

In this case, as in the case of the above-described S102, the mechanical control unit 13 checks if there is another contending calibration (S119).

In the case of the present embodiment, there are calibrations (the bias calibration and the I/O calibration) being performed, and moreover, the calibrations include a calibration of the same type as the requested calibration.

Hence, the performance of the bias calibration, the request for which is made by the image output unit 16, is not allowed and such an event is notified to the image output unit 16 (S120).

Note that the performance of the two calibrations being performed continues until each process ends.

The sequence of calibration contention control is described above with reference to the sequence diagram of FIG. 3; this mainly describes the details of the operations from steps S1 to S8 of the flowchart of FIG. 2.

As described above, according to the image forming apparatus 10 of the present embodiment, by mutual control of the calibration performance managing unit 121, the calibration performance unit 122, and/or the calibration history managing unit 123, a calibration of the same type as the calibration being performed is not performed when there is a calibration being performed. In addition, even when there is no calibration being performed, the performance of a calibration of the same type within a preset, predetermined period of time is avoided.

By this, in the image forming apparatus 10 of the present embodiment, an effective calibration process is performed while suppressing unnecessary performance, making it possible to perform image formation and output with a certain image quality being maintained, and to suppress the consumption of extra toner. In addition, the waiting time during which a print process cannot be performed because calibration is being performed, can be reduced as possible; accordingly, the work efficiency of the entire image forming apparatus can be improved.

Furthermore, an optimum interval for calibration performance and the like can be set based on the type of calibration; thus, a flexible operation can be performed according to the type or content of an image, user's status of use or the like, enabling a more efficient image formation process.

An image forming apparatus of the present invention is described above with reference to a preferred embodiment. However, needless to say, calibration contention control according to the present invention is not limited to the one described in the above embodiment and various changes may be made within the scope of the present invention.

For example, an image forming apparatus of the present invention may be a copier or facsimile machine or a complex machine having both of these functions, as well as a printer.

The present invention can be applied to an image forming apparatus such as a printer, a copier, or a facsimile machine. In particular, the present invention can be suitably applied to an image forming apparatus having a plurality of types of calibration functions.

What is claimed is:

1. An image forming apparatus including one or two or more types of calibration functions that are performed to maintain a predetermined image quality for an output image, the apparatus comprising:
a calibration performance unit that performs a predetermined calibration; and
a calibration performance managing unit that controls the calibration performance unit based on a request for a predetermined calibration to perform the requested predetermined calibration when no calibration is performed, and controls the calibration performance unit not to perform the requested calibration of the same type when a request is made for another calibration of a same type as the calibration being performed while a calibration is being performed.

2. The image forming apparatus according to claim 1, wherein when a request is made for another calibration of a different type from the calibration being performed while a calibration is being performed, the calibration performance managing unit controls the calibration performance unit to wait for the calibration being performed to end and then perform the requested calibration of the different type.

3. The image forming apparatus according to claim 1, further comprising a calibration history managing unit that stores calibration history information including a type and an end time of a calibration performed by the calibration performance unit,
wherein when a request for a calibration is made, the calibration performance managing unit controls, the calibration performance unit not to perform the requested calibration based on a determination that a calibration of a same type as the requested calibration is already performed within a predetermined period of time by the calibration history information stored in the calibration history managing unit.

4. The image forming apparatus according to claim 1, wherein calibration to be performed by the calibration performance unit includes an I/O calibration and/or a bias calibration.

5. A calibration control method which is performed by a calibration performance managing unit, in an image forming apparatus having one or two or more types of calibration functions, the method comprising:
controlling a calibration performance unit not to perform the requested calibration of the same type when, while a calibration is being performed, a request is made for another calibration of a same type as the calibration being performed,
controlling the calibration performance unit to wait for the calibration being performed to end and then perform the requested calibration of the different type when, while a calibration is being performed, a request is made for another calibration of a different type from the calibration being performed;
storing calibration history information including a type and an end time of a calibration performed by the calibration performance unit; and
controlling, when a request for a calibration is made, the calibration performance unit not to perform the requested calibration based on a determination that a calibration of a same type as the requested calibration is performed within a predetermined period of time by the calibration history information stored in the calibration history managing unit.

6. A storage medium having stored thereon an image processing program that allows a computer that composes an image forming apparatus including one or two or more types of calibration functions which are performed to maintain a predetermined image quality for an output image, to function as:
calibration performance means for performing a predetermined calibration; and
calibration performance management means for controlling, the calibration performance means based on a request for a predetermined calibration to perform the requested predetermined calibration when no calibration is performed, and controlling, the calibration performance means not to perform the requested calibration of the same type when, while a calibration is being performed, a request is made for another calibration of a same type as the calibration being performed.

7. The storage medium in which the image processing program is recorded according to claim 6, wherein the image processing program allows the calibration performance management means to function as:
means for controlling the calibration performance means to wait for the calibration being performed to end and then perform the requested calibration of the different type when, while a calibration is being performed, a request is made for another calibration of a different type from the calibration being performed.

8. The storage medium stored thereon an image processing program according to claim 6,
wherein the image processing program allows the computer that composes an image forming apparatus having one or two or more types of calibration functions which are performed to maintain a predetermined image quality for an output image to function as calibration history management means for storing calibration history information including a type and an end time of a calibration performed by the calibration performance means,
and the image processing program allows, when a request for a calibration is made, the calibration performance management means to function as means for controlling, the calibration performance means not to perform the requested calibration based on a determination that a calibration of a same type as the requested calibration is already performed within a predetermined period of time by the calibration history information stored in the calibration history management means.
